(19) United States
(12) Patent Application Publication
(10) Pub. No.: US 2025/0117031 A1
(43) Pub. Date: Apr. 10, 2025

(54) LIFT DEVICE WITH FOLLOW SURFACE SYSTEM

(71) Applicant: Oshkosh Defense LLC., Oshkosh, WI (US)

(72) Inventor: Peter Gilbert, Oshkosh, WI (US)

(73) Assignee: Oshkosh Defense LLC., Oshkosh, WI (US)

(21) Appl. No.: 18/813,590

(22) Filed: Aug. 23, 2024

Related U.S. Application Data
(60) Provisional application No. 63/534,435, filed on Aug. 24, 2023.

(51) Int. Cl. G05D 3/12; B66F 11/04

(52) U.S. Cl. CPC G05D 3/12; B66F 11/044

(57) ABSTRACT

A lift device includes a base assembly, a lift assembly, a platform assembly, and a control system. The lift assembly is coupled with the base assembly. The lift assembly is configured to raise or lower. The platform assembly is coupled with an end of the lift assembly. The platform assembly is configured to be raised and lowered by the lift assembly. The control system includes processing circuitry. The processing circuitry is configured to receive a user input,. The user input includes a request to move the platform assembly in a direction along a wall surface relative to the wall surface while maintaining a constant distance from the wall surface and orientation relative to the wall surface. The processing circuitry is configured to operate at least the lift assembly to move the platform assembly in the direction along the wall surface.

### CROSS-REFERENCE TO RELATED PATENT APPLICATION

This application claims the benefit of and priority to U.S. Provisional Application No. 63/534,435, filed Aug. 24, 2023, the entire disclosure of which is incorporated by reference herein.

### BACKGROUND

The present disclosure relates to lift devices. More specifically, the present disclosure relates controlling lift devices.

### SUMMARY

One embodiment of the present disclosure is a lift device. The lift device includes a base assembly, a lift assembly, a platform assembly, and a control system. The lift assembly is coupled with the base assembly. The lift assembly is configured to raise or lower. The platform assembly is coupled with an end of the lift assembly. The platform assembly is configured to be raised and lowered by the lift assembly. The control system includes processing circuitry. The processing circuitry is configured to receive a user input,. The user input includes a request to move the platform assembly in a direction along a wall surface relative to the wall surface while maintaining a constant distance from the wall surface and orientation relative to the wall surface. The processing circuitry is configured to operate at least the lift assembly to move the platform assembly in the direction along the wall surface.

In some embodiments, the user input includes a request to move the platform assembly upwards along the wall surface, downwards along the wall surface, left along the wall surface, or right along the wall surface. In some embodiments, the user input includes a request to move the platform assembly in the direction along the wall surface in a fixed coordinate system that is offset from the wall surface.

In some embodiments, the control system is configured to operate at least the lift assembly to move the platform assembly in the direction along a concave surface. In some embodiments, the control system is configured to operate at least the lift assembly to move the platform assembly in the direction along a convex surface.

In some embodiments, the control system is configured to operate at least the lift assembly to move the platform assembly in the direction along a flat surface. In some embodiments, the control system further includes multiple sensors disposed on the platform assembly. The sensors are configured to measure a distance between the platform assembly and the wall surface. The processing circuitry is configured to operate the lift assembly according to the request to move the platform assembly in the direction along the wall surface while maintaining a specific distance between the platform assembly and the wall surface based on feedback from the sensors.

Another embodiment of the present disclosure is a system for a lift device. The lift device includes a platform assembly and processing circuitry. The platform assembly is coupled with an end of a lift assembly. The platform assembly is configured to be raised and lowered by the lift assembly. The processing circuitry is configured to receive a user input. The user input includes a request to move the platform assembly in a direction along a local coordinate system of a wall surface. The processing circuitry is also configured to operate at least the lift assembly to move the platform assembly in the direction along the wall surface.

In some embodiments, the user input includes a request to move the platform assembly upwards along the wall surface, downwards along the wall surface, left along the wall surface, or right along the wall surface. In some embodiments, the user input includes a request to move the platform assembly in the direction along the wall surface in a fixed plane that is offset from the wall surface.

In some embodiments, the system is configured to operate at least the lift assembly to move the platform assembly in the direction along a concave surface. In some embodiments, the system is configured to operate at least the lift assembly to move the platform assembly in the direction along a convex surface. In some embodiments, the system is configured to operate at least the lift assembly to move the platform assembly in the direction along a flat surface.

In some embodiments, the system further includes multiple sensors disposed on the platform assembly. The sensors are configured to measure a distance between the platform assembly and the wall surface. The processing circuitry is configured to operate the lift assembly according to the request to move the platform assembly in the direction along the wall surface while maintaining a specific distance between the platform assembly and the wall surface based on feedback from the sensors.

Another embodiment of the present disclosure is a method of controlling a lift device. The method includes obtaining a user input indicating a requested direction of motion of a platform assembly relative to a wall surface. The method also includes determining a control of actuators of a lift assembly on which the platform assembly is coupled. The method includes operating the actuators of the lift assembly to move the platform assembly in the requested direction relative to the wall surface.

In some embodiments, the requested direction includes a direction of motion relative to a local coordinate system of the wall surface. In some embodiments, the wall surface includes a concave or convex wall surface and the requested direction of motion includes a requested direction of motion of the platform assembly along the concave or convex wall while maintaining a constant distance and orientation of the platform assembly relative to the concave or convex wall.

In some embodiments, the method includes obtaining sensor data from multiple sensors disposed on the platform assembly. The sensors are configured to measure a distance between the platform assembly and the wall surface. The method also includes determining the control of the actuators based on the sensor data in order to move the platform assembly in the requested direction relative to the wall surface while maintaining a specific distance and orientation between the platform assembly and the wall surface based on feedback from the sensors.

In some embodiments, the user input includes an upwards, downward, left, or right direction of motion relative to the wall surface. In some embodiments, the control of the actuators are determined to move the platform assembly in the upwards, downward, left, or right direction of motion relative to the wall surface while maintaining a specific distance between the platform assembly and the wall surface.

In some embodiments, the method includes obtaining a selection of a mode of operation from multiple modes of operation including a distance mode or a fixed plane mode. In the distance mode, the method comprises operating the lift assembly to maintain a current distance between the platform assembly and the wall surface. In the fixed plane mode, the method includes operating the lift assembly to maintain the platform assembly within a fixed plane of movement at a fixed orientation.

### BRIEF DESCRIPTION OF THE DRAWINGS

FIG. 1 is a perspective view of a lift device, according to some embodiments

FIG. 2 is a perspective view of a base of the lift device of FIG. 1, according to some embodiments.

FIG. 3 is a perspective view of an axle assembly of the lift device of FIG. 1, according to some embodiments.

FIG. 4 is a perspective view of a platform assembly of the lift device of FIG. 1, according to some embodiments.

FIG. 5 is a top view of the lift device of FIG. 1 including a control system for following a flat surface, according to some embodiments.

FIG. 6 is a side view of the lift device of FIG. 5, according to some embodiments.

FIG. 7 is a top view of the lift device of FIG. 5 following a concave surface, according to some embodiments.

FIG. 8 is a side view of the lift device of FIG. 7, according to some embodiments.

FIG. 9 is a top view of the lift device of FIG. 5 following a convex surface, according to some embodiments.

FIG. 10 is a side view of the lift device of FIG. 9, according to some embodiments.

FIG. 11 is a block diagram of the control system of FIG. 5 configured to receive user inputs to adjust position of a platform assembly relative to a wall surface and control actuators of the lift device to move the platform assembly along the wall surface, according to some embodiments.

FIG. 12 is a flow diagram of a process for operating a lift device to follow a wall surface, according to some embodiments.

FIG. 13 is a perspective view of a platform assembly for the lift device of FIG. 5 including multiple platform sensors, according to some embodiments.

FIG. 14 is a diagram of articulable and adjustable components of the lift device of FIG. 1 illustrated by vectors, according to some embodiments.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the FIGURES, a lift device includes a control system that is configured to receive a user input and operate the lift device in a manner relative to a surface at which a platform of the lift device is proximate. In this way, instead of commanding direct extension or retraction of a particular member (e.g., a telescoping boom segment), the operator may provide a requested input to move upwards or downwards the surface, left or right on the surface, etc., while maintaining a desired distance from the surface. The lift device may include a controller that receives the user input and obtains feedback from sensors to determine specific controls of one or more controllable components to cause motion of the platform relative to the surface according to the user input.

### Lift Device

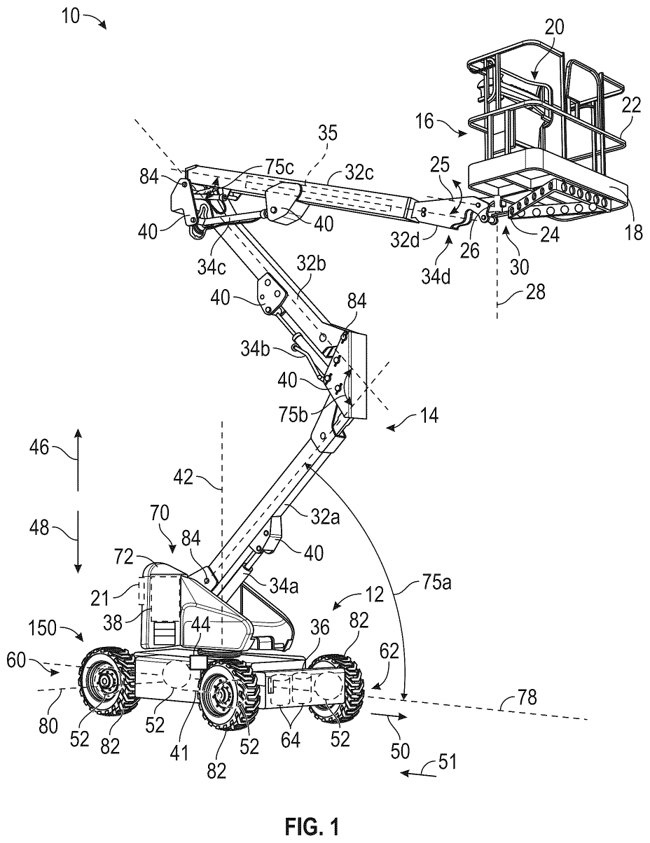

Referring to FIG. 1, a lifting apparatus, lift device, or mobile elevating work platform (MEWP) (e.g., a telehandler, an electric boom lift, a towable boom lift, a lift device, a fully electric boom lift, etc.), shown as lift device 10 includes a base assembly 12 (e.g., a base, a support assembly, a drivable support assembly, a support structure, a chassis, etc.), a platform assembly 16 (e.g., a platform, a terrace, etc.), and a lift assembly 14 (e.g., a boom, a boom lift assembly, a lifting apparatus, an articulated arm, a scissors lift, etc.). The lift device 10 includes a front end (e.g., a forward-facing end, a front portion, a front, etc.), shown as front 62, and a rear end (e.g., a rearward facing end, a back portion, a back, a rear, etc.,) shown as rear 60. The lift assembly 14 is configured to elevate the platform assembly 16 in an upward direction 46 (e.g., an upward vertical direction) relative to the base assembly 12. The lift assembly 14 is also configured to translate the platform assembly 16 in a downward direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitate motion of the lift device 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfers power (e.g., mechanical energy) from one or more electric motors 52 and/or the prime mover 41 to the tractive elements 82. The tractive elements 82 and electric motors 52 (or prime mover 41) can facilitate a driving and/or steering function of the lift device 10. In some embodiments, the electric motors 52 are optional, and the tractive elements 82 are powered or driven by an internal combustion engine.

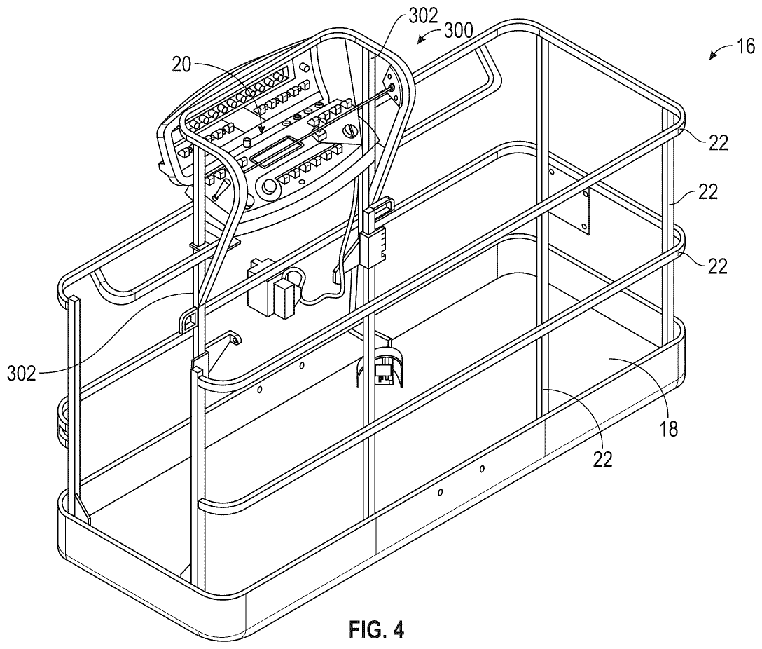

With additional reference to FIG. 4, the platform assembly 16 is shown in further detail. The platform assembly 16 is configured to provide a work area for an operator of the lift device 10 to stand/rest upon. The platform assembly 16 can be pivotally coupled to an upper end of the lift assembly 14. The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the lift device 10 uses internal combustion engines, hydraulics, a hydraulic system, pneumatic cylinders, etc.

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members that couple with the substantially horizontal members. The vertical structural members can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIG. 1, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 to facilitate rotation of the platform assembly 16 about an axis 28 (e.g., a vertical axis). The frame 24 can also rotatably/pivotally couple with the lift assembly 14 such that the frame 24 and the platform assembly 16 can pivot about an axis 25 (e.g., a horizontal axis).

The lift assembly 14 includes one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The lift device 10 includes a lower lift arm 32a, a central or medial lift arm 32b, and an upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the lift device 10. The intermediate lift arm 32d may extend into an inner volume of the upper lift arm 32c and extend and/or retract. The lower lift arm 32a and the medial lift arm 32b may be referred to as “the boom” of the overall lift device 10 assembly. The intermediate lift arm 32d can be configured to couple (e.g., rotatably, hingedly, etc.), with the platform assembly 16 to facilitate levelling of the platform assembly 16.

The lift arms 32 are driven to hinge or rotate relative to each other by actuators 34a, 34b, 34c, and 34d (e.g., electric linear actuators, linear electric arm actuators, hydraulic cylinders, etc.). The actuators 34a, 34b, 34c, and 34d can be mounted between adjacent lift arms to drive adjacent lift arms to hinge or pivot (e.g., rotate some angular amount) relative to each other about pivot points 84. The actuators 34a, 34b, 34c, and 34d can be mounted between adjacent lift arms using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 75a defined between a centerline of the lower lift arm 32a and the longitudinal axis 78 (angle 75a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 75a to facilitate lowering of the platform assembly 16 (e.g., moving the platform assembly 16 at least partially along the downward direction 48). Similarly, the actuator 34b is configured to extend to increase the angle 75b defined between centerlines of the lower lift arm 32a and the medial lift arm 32b and facilitate elevating of the platform assembly 16. Similarly, the actuator 34b is configured to retract to decrease the angle 75b to facilitate lowering of the platform assembly 16. The electric actuator 34c is similarly configured to extend/retract to increase/decrease the angle 75c, respectively, to raise/lower the platform assembly 16. The actuators 34 may be hydraulic actuators, electric actuators, pneumatic actuators, etc.

The actuators 34a, 34b, 34c, and 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 (e.g., the pivot motor 26) can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

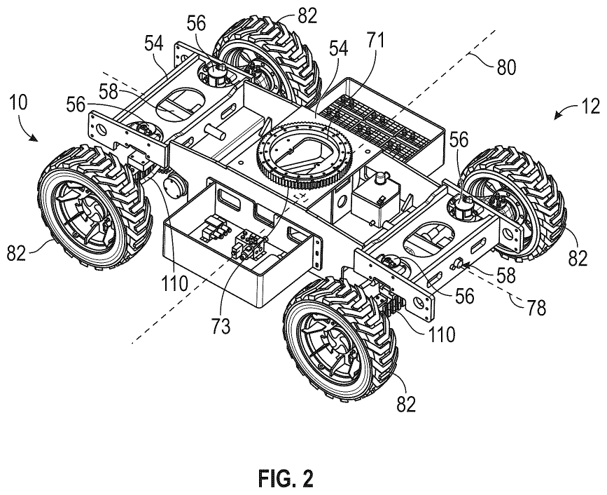

Referring to FIGS. 1 and 2, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slew bearing 71 (e.g., the slew bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slew bearing 71 by an electric motor, an electric turntable motor, an electric rotary actuator, a hydraulic motor, etc., shown as the turntable motor 44. The turntable motor 44 can be configured to drive a geared outer surface 73 of the slew bearing 71 that is rotatably coupled to the base 36 about the slew bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 38 that is configured to operate any of the motors, actuators, etc., of the lift device 10. The controller 38 can be configured to receive sensory input information from various sensors of the lift device 10, user inputs from the user interface 20 (or any other user input device such as a key-start or a push-button start), etc. The controller 38 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 150. The steering system 150 is configured to drive tractive elements 82 to pivot for a turn of the lift device 10. The steering system 150 can be configured to pivot the tractive elements 82 in pairs (e.g., to pivot a front pair of tractive elements 82), or can be configured to pivot tractive elements 82 independently (e.g., four-wheel steering for tight-turns).

It should be understood that while the lift device 10 as described herein is described with reference to batteries, electric motors, etc., the lift device 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

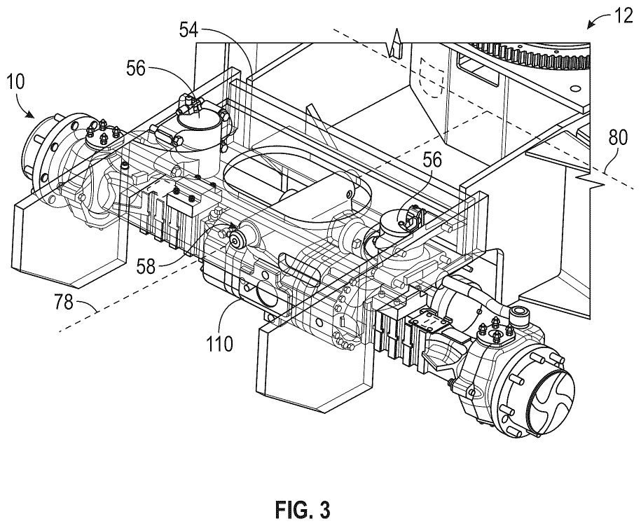

Referring now to FIGS. 2 and 3, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotally coupled with lateral frame members 110 (e.g., axles, frame members, beams, bars, etc.) at opposite longitudinal ends of the longitudinally extending frame member 54. For example, the lateral frame members 110 may be pivotally coupled with the longitudinally extending frame member 54 at a front end and a rear end of the longitudinally extending frame member 54. The lateral frame members 110 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 110 (e.g., a front lateral frame member 110 or a rear lateral frame member 110) or the longitudinally extending frame member 54 and the receiving portion is coupled to the other of the longitudinally extending frame member 54 and the lateral frame member 110. For example, the pin may be coupled with longitudinally extending frame member 54 and the receiving portion can be coupled with one of the lateral frame members 110 (e.g., integrally formed with the front lateral frame member 110).

In some embodiments, the longitudinally extending frame member 54 and the lateral frame members 110 are integrally formed or coupled (e.g., fastened, welded, riveted, etc.) to define the base 36. In still other embodiments, the base 36 is integrally formed with the longitudinally extending frame member 54 and/or the lateral frame members 110. In still other embodiments, the base 36 is coupled with the longitudinally extending frame member 54 and/or the lateral frame members 110.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 110. When the axle actuators 56 extend, an end of a rod of the levelling actuators can contact the surface of lateral frame member 110 and prevent relative rotation between lateral frame member 110 and longitudinally extending frame member 54. In this way, the relative rotation/pivoting between the lateral frame member 110 and the longitudinally extending frame member 54 can be locked (e.g., to prevent rolling of the longitudinally extending frame member 54 relative to the lateral frame members 110 during operation of the lift assembly 14). The axle actuators 56 can receive power from the batteries 64, which can allow the axle actuators 56 to extend or retract. The axle actuators 56 receive control signals from controller 38.

### Follow Surface System

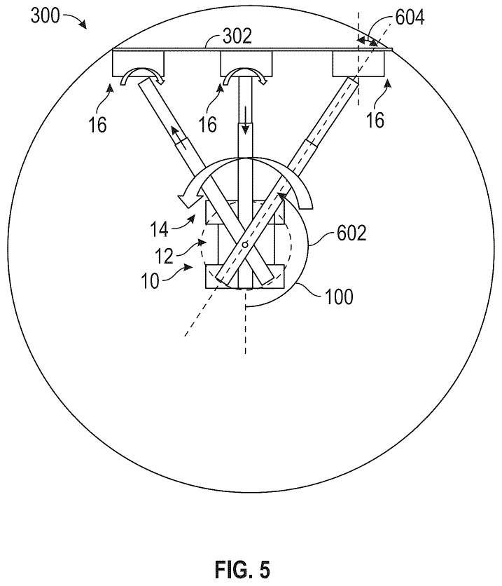

Referring to FIGS. 5-12, the lift device 10 can include a detection and control system 100 that is configured to facilitate maintaining a desired or required distance between the platform assembly 16 and a wall surface (e.g., a flat wall surface, a concave wall surface, a convex wall surface, etc.). In some embodiments, the detection and control system 100 is configured to operate various controllable elements of the lift assembly 14, the base assembly 12, and the platform assembly 16 based on a user input (e.g., to raise or lower the platform assembly 16) while maintaining a desired or required distance between the platform assembly 16 and the wall surface, and while maintaining a desired or threshold orientation of the platform assembly 16. Some systems require the operator to manually control an angle 602 of the turntable 70, manually control the actuators 34 to adjust angle 75a, angle 75b, and angle 75c, and manually control the extension actuator 35 to increase or decrease a distance 610 of the upper lift arm 32c and the intermediate lift arm 32d. The detection and control system 100 can be configured to automatically determine controls for the turntable 70, the actuators 34, the extension actuator 35, and/or the motor 26 such that the platform assembly 16 is constrained to move in a plane or moves to maintain a certain distance from a wall surface. In this way, the operator may provide control inputs such as up, down, left right, closer or further to the wall, and the control system 100 automatically operates the lift device 10 to appropriately control the turntable 70, the actuators 34, and the motor 26.

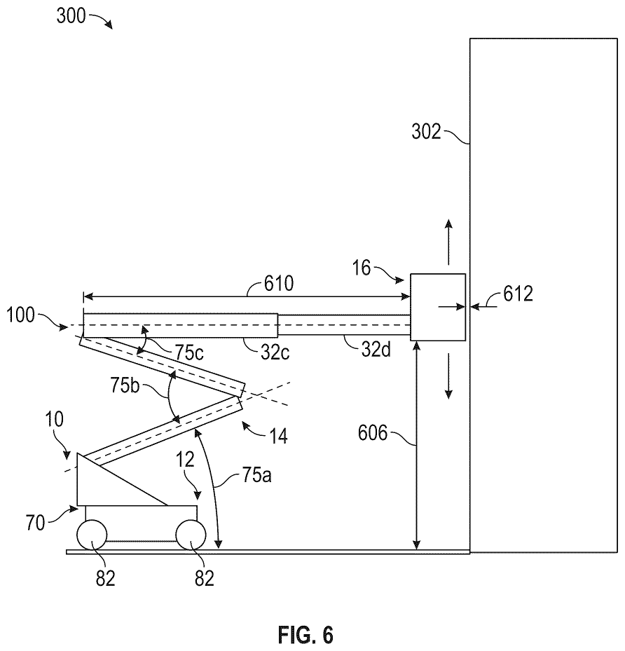

Referring to FIGS. 5 and 6, a diagram 300 illustrating the lift device 10 servicing a flat surface 302 (e.g., a flat wall, a flat surface, a side of a building, etc.) is shown. In some embodiments, the lift assembly 14 is configured to raise or lower the platform assembly 16 so that the platform assembly 16 is a distance 606 above a ground surface in order to reach an elevated location (e.g., so that an operator that is standing on the platform assembly 16 can service a portion of the wall 302). The detection and control system 100 can be transitioned into either a fixed plane mode such that the control system 100 automatically controls the turntable 70 and the lift assembly 14 responsive to control requests from the user (e.g., request to move up the wall, request to move down the wall, request to move to the left or the right on the wall, request to move closer or farther away from the wall, etc.) or into a distance-mode so that the control system 100 automatically controls the turntable 70 and the lift assembly 14 to maintain a specific distance 612 between the platform assembly 16 and the wall 302. In this way, the control system 100 can receive control requests from the user to adjust positioning of the platform assembly 16 relative to the wall surface 302 (e.g., upwards, downwards, left, right, closer, further away, etc.) and can determine appropriate control for the turntable 70 and the lift assembly 14 (e.g., actuators and/or motors thereof) in order to achieve the requested adjustment in position of the platform assembly 16 relative to the wall surface 302. In some embodiments, the control system 100 is also configured to determine controls for the tractive elements 82 in order to achieve the control request (e.g., transport closer to the wall 302 or further away from the wall 302 as necessary to achieve the control request). The fixed plane mode can be useful for flat walls such as for painting work, window cleaning work, masonry, etc.

In some embodiments, FIGS. 5 and 6 illustrate control and operation of the lift device 10 when operating according to a fixed plane mode of operation. For example, the operator may control or operate the lift device 10 using a user interface (e.g., via a joystick) until achieving a desired distance between the wall 302 and the platform assembly 16 (e.g., by operating the actuators 34, the rotator 30, the motor 26, the motors 52, the turntable motor 44, the extension actuator 35, etc.), then transitioning the lift device 10 into the fixed plane mode of operation. In some embodiments, in the fixed plane mode of operation, the operator can provide user inputs or control requests with the same user interface (e.g., via the joystick) or a separate user interface to move the platform assembly 16 relative to the wall 302 (e.g., along a fixed plane). In this way, the operator can provide relative inputs (e.g., move up, move down, move left, move right, etc. relative to the wall 302, increase distance 606, decrease distance 606, etc.) instead of absolute inputs (e.g., extend the extension actuator 35, retract the actuator 34a, etc.). The fixed plane mode of operation provides an intuitive control of the lift device 10. In some embodiments, an operator can control the operation of the lift device in both absolute terms and relative to the wall 302 in the fixed plane mode of operation via a single user interface. In some embodiments, there are separate user interfaces for each type of control. In some embodiments, the lift device 10 uses sensor feedback from the platform assembly 16 indicating the distance 612 in order to control operation of the turntable 70, the lift assembly 14, etc.

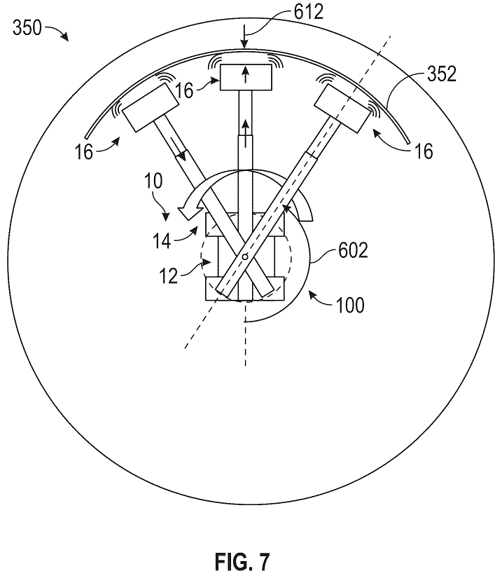

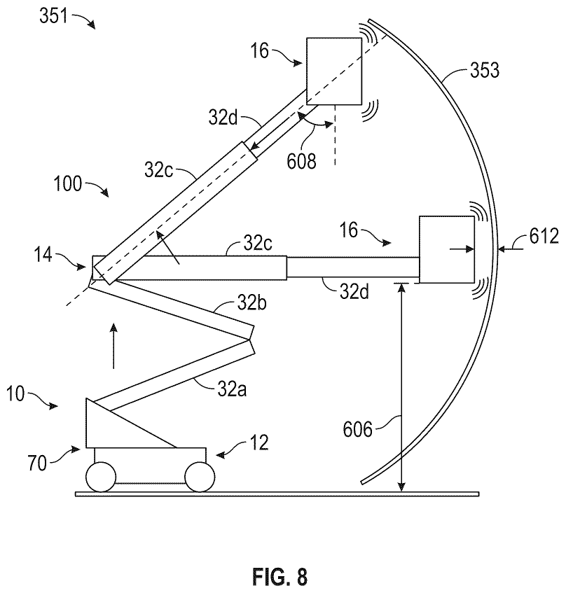

Referring to FIG. 7, a diagram 350 illustrates a top view showing the lift device 10 servicing a vertically concave wall 352, according to some embodiments. FIG. 8 similarly shows a diagram 351 of the lift device 10 servicing a horizontally concave wall 353. In some embodiments, the lift device 10 is equipped with a full suite of sensors on the platform assembly 16 so that the detection and control system 100 can obtain a field of view of the vertically concave wall 352 or the horizontally concave wall 353 and operate to maintain the platform assembly 16 a desired distance from the wall while operating so that the platform assembly 16 provides access to different parts of the vertically concave wall 352 or the horizontally concave wall 353. In some embodiments, the control system 100 uses real-time feedback from the sensors of the platform assembly 16 to determine the distance 612 between the platform assembly 16 and the vertically concave wall 352 or the horizontally concave wall 353. In some embodiments, the control system 100 is configured to receive control inputs from the operator (e.g., via a joystick) and operate the turntable 70, the lift assembly 14, etc., to achieve the control inputs. The control inputs may be requests for movement of the platform assembly 16 relative to the wall 353 or the wall 352 (e.g., move up the wall, move left or right on the wall, etc.) as opposed to absolute commands to adjust a specific actuator of the lift assembly 14. The concave wall 352 or 353 may be a boiler interior, an architectural dome, etc.

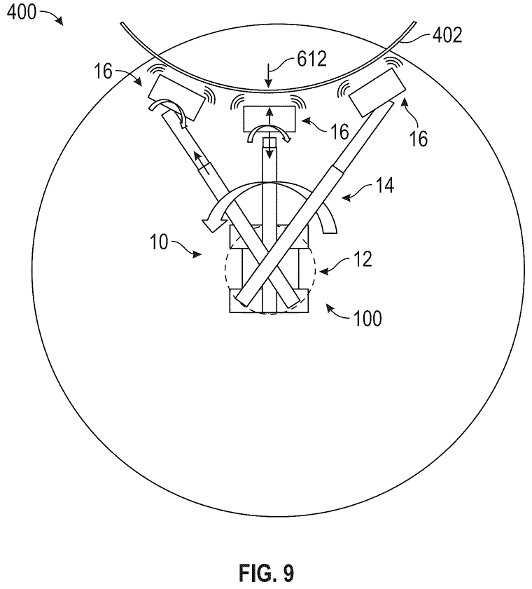

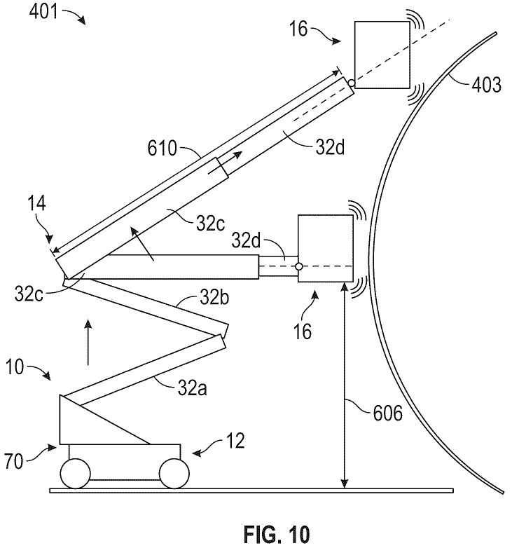

Referring to FIG. 9, a diagram 400 illustrates a top view showing the lift device 10 servicing a vertically convex wall 402, according to some embodiments. FIG. 10 illustrates a side view showing the lift device 10 servicing a horizontally convex wall 403, according to some embodiments. In some embodiments, the platform assembly 16 includes the full suite of sensors and is configured to be operated similarly as described in greater detail above with reference to FIGS. 7 and 8. The convex wall 402 or 403 may be a silo, a chemical tank, etc.

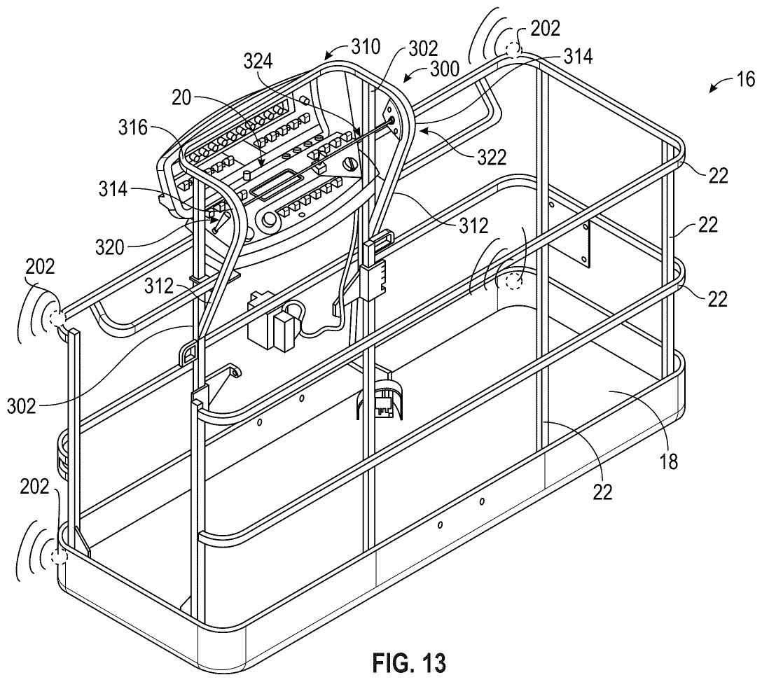

Referring to FIG. 13, the platform assembly 16 may be equipped with one or more sensors 202 (e.g., lidar sensors, ultrasonic sensors, infrared sensors, cameras, imaging devices, etc.) that are configured to obtain sensor data that is indicative of a surrounding area of the platform assembly 16. In some embodiments, the sensors 202 are positioned on the deck 18 or on one or more rails 22 of the platform assembly 16. The sensors 202 are configured to obtain sensor data indicating a relative distance between the platform assembly 16 and a wall surface (e.g., the flat surface 302, the wall 352, the wall 353, the wall 402, the wall 403, etc.). In some embodiments, the sensors 202 can provide information that is used to detect if the wall surface is flat, concave, convex, irregularly shaped, etc., and to determine a map (e.g., a surface map, a graphical representation, etc.) of the wall surface. In some embodiments, the sensors 202 are configured to provide their information to a controller (e.g., controller 102) of the control system 100 so that the control system 100 can be configured to appropriately adjust the position of the platform assembly 16 as requested by the operator.

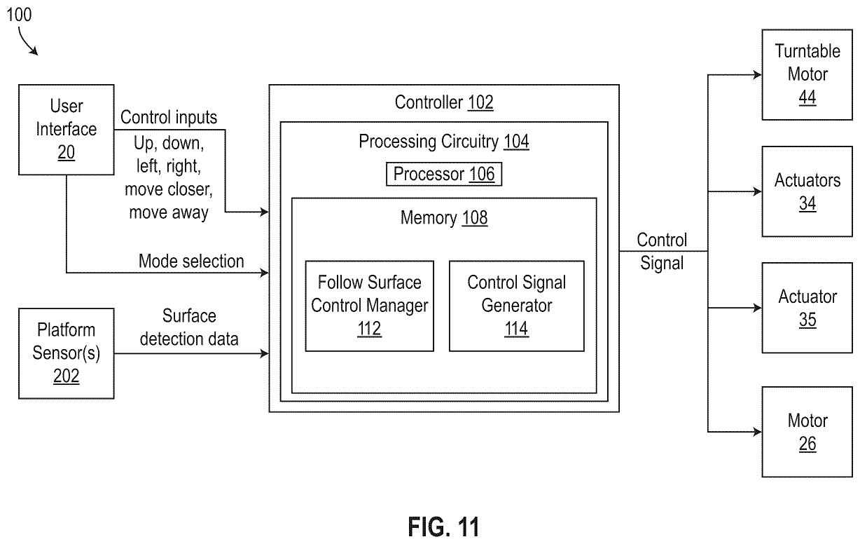

Referring to FIG. 11, the detection and control system 100 for the lift device 10 includes a controller 102, the user interface 20, the platform sensors 202, the turntable motor 44 (e.g., an electric motor, a hydraulic motor, etc.), the actuators 34 (e.g., the actuators 34a, 34b, 34c, and 34d), and the extension actuator 35. The controller 102 may receive inputs from the user interface 20 and sensor data (e.g., surface detection data) from the platform sensors 202. The user interface 20 can include one or more joysticks that the operator may operate to provide relative control inputs (e.g., inputs indicating a desired movement or motion of the platform assembly 16 relative to the wall surface) for the platform assembly 16. The controller 102 may receive the control inputs (move up relative to the wall, move down relative to the wall, move left along the wall, move right along the wall, move closer to the wall, move away from the wall, etc.) and determine controls for each of the turntable motor 44, the actuators 34, the actuator 35, and the motor 26 to achieve the control input provided by the user interface 20. In some embodiments, the user interface 20 also includes one or more buttons, switches, dials, etc., to transition the control system 100 between different modes of operation (e.g., a follow surface mode, a fixed plane mode, a manual control mode, etc.). In some embodiments, transitioning the control system 100 between the different modes causes the controller 102 to interpret control inputs from the user interface 20 different (e.g., so that the joysticks result in different controls of the lift device 10).

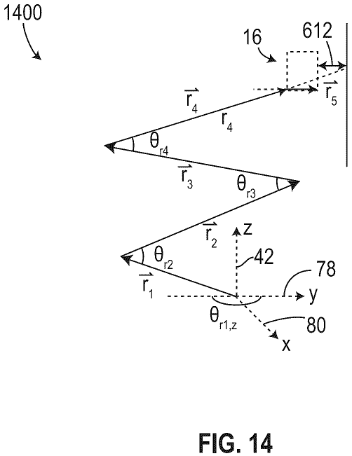

Referring particularly to FIGS. 11 and 14, the controller 102 can be configured to construct and solve a vector analysis problem in order to determine required changes for the turntable 70, the lift arm 32a, the lift arm 32b, the lift arm 32c, the lift arm 32d, and the platform assembly 16. FIG. 14 illustrates a constructed vector problem in a Cartesian coordinate system. It should be understood that the vector problem may similarly be constructed by the controller 102 in a spherical coordinate system, a cylindrical coordinate system, a polar coordinate system, etc. The vectors shown in FIG. 14 are illustrative only to demonstrate one way that the controller 102 may construct the vector problem to determine specific control inputs for each of the actuators 34, the actuator 35, the motor 26, the turntable motor 44, etc. In some embodiments, the controller 102 does not construct and solve a vector problem and instead uses a predetermined set of instructions or processes to determine controls for the turntable motor 44, the actuators 34, the actuator 35, and the motor 26. In some embodiments, the controller 102 is configured to use real-time feedback from the platform sensors 202 in a closed loop control scheme to determine controls for the turntable motor 44, the actuators 34, the actuator 35, and the motor 26.

Referring to FIG. 14, a vector diagram 1400 includes a first vector \vec{r}₁ that extends from the location at which the turntable 70 rotates about the central axis 42 to a pivot point between the lift arm 32a and the turntable 70, a second vector \vec{r}₂ that corresponds to the lift arm 32a, extending from the pivot point between the lift arm 32a and the turntable 70 to a pivot point between the lift arm 32a and the lift arm 32b, a third vector \vec{r}₃ that corresponds to the lift arm 32b and extends from the pivot point between the lift arm 32a and a pivot point between the lift arm 32c and the lift arm 32b, a fourth vector \vec{r}₄ that corresponds to the lift arm 32c that extends between the pivot point between the lift arm 32b and the lift arm 32c to a pivot point between the lift arm 32c and the platform assembly 16. In some embodiments, the controller 102 can determine controls for the turntable motor 44 to change a value of the angle 602 as measured about the central axis 42, illustrated as θ_{r1,z} in FIG. 14. In some embodiments, the first vector \vec{r}₁ is a fixed length vector that can only rotate about the central axis 42 (e.g., the z-axis). The controller 102 can also determine controls for the lift actuator 34a to adjust an angle θᵣ₂ between the first vector and the second vector (e.g., between the turntable 70 and the lift arm 32a) or to adjust the angle 75a between the lift arm 32a and the longitudinal axis 78. The controller 102 can also determine controls for the lift actuator 34b to adjust an angle θᵣ₃ between the second vector and the third vector (e.g., the angle 75b illustrated in FIG. 1). The controller 102 can also determine controls for the lift actuator 34c to adjust an angle θᵣ₄ between the third vector and the fourth vector (e.g., the angle 75c as illustrated in FIG. 1). The controller 102 can also determine controls for the extension actuator 35 to increase or decrease a length of the fourth vector (e.g., to drive the intermediate lift arm 32d to extend or retract relative to the lift arm 32c). The controller 102 can also determine controls for the actuator 34d and the motor 26 to thereby change orientation of the platform assembly 16 relative to the intermediate lift arm 32d about the axis 25 and the axis 28 (e.g., illustrated by the fifth vector \vec{r}₅).

Referring again to FIG. 11, the controller 102 includes processing circuitry 104, a processor 106, and memory 108. Processing circuitry 104 can be communicably connected to a communications interface such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by processing circuitry 104 and/or processor 106) one or more processes described herein.

In some embodiments, controller 102 is implemented within a single computer (e.g., one server, one housing, etc.). In various other embodiments controller 102 can be distributed across multiple servers or computers (e.g., that can exist in distributed locations).

Referring still to FIG. 11, the controller 102 includes a follow surface control manager 112 that is configured to determine appropriate controls or required relative orientations of various arms or components of the lift device 10 based on the control inputs, and a control signal generator 114 that is configured to generate and provide control signals to the turntable motor 44, the actuators 34, the extension actuator 35, and the motor 26. The follow surface control manager 112 may be configured to operate according to different modes (e.g., the fixed plane mode, the follow surface mode, etc.) to determine appropriate orientations or controls of the lift device 10 (e.g., values of the angle of the turntable 70, values of the angles between the vectors as determined by the actuators 34, values of the required length for the fourth vector as determined by the extension actuator 35, etc.). The control signal generator 114 is configured to use the determined angles for the turntable 70, the lift arms 32, etc., or time rate of change of the various angles (e.g., as represented in FIG. 14) and generate and provide control signals for the turntable motor 44, the actuators 34, the actuator 35, and the motor 26 so that the turntable motor 44, the actuators 34, the actuator 35, and the motor 26 operate to achieve the requested function provided by the user interface 20.

Referring again to FIGS. 11 and 14, when the controller 102 is in the fixed plane mode and receives a control input to move the platform assembly 16 upwards along the wall, downwards along the wall, left or right along the wall, etc., the follow surface control manager 112 may determine changes for the angle θ_{r1,z} of the turntable 70, the angle θᵣ₂ or the angle 75a, the angle 75b, the angle 75c, the length 610, the angle of the platform assembly 16 relative to the intermediate lift arm 32d about the axis 28 (e.g., an angle 604 shown in FIG. 5), the angle of the platform assembly 16 relative to the intermediate lift arm 32d about the axis 25 (e.g., an angle 608 as shown in FIG. 8), etc., to achieve movement of the platform assembly 16 in the requested direction (or combination of directions) in the fixed plane. The follow surface control manager 112 may then provide the determined changes for the various angles of the lift device 10 to the control signal generator 114 which uses the changes or new values to generate control signals for the turntable motor 44, the actuators 34, the actuator 35, and the motor 26 to achieve the requested movement of the platform assembly 16 along the fixed plane. The follow surface control manager 112 may construct and solve a vector problem as shown in FIG. 14 in order to determine new values of angles or lengths, changes to the angles or lengths, or rate of change for the angles and lengths in order to achieve the requested movement of the platform assembly 16 along the fixed plane.

Referring still to FIGS. 11 and 14, the follow surface control manager 112 can also use the surface detection data provided by the platform sensors 202 to determine adjustments or new values for the turntable 70, the angle of the lift arm 32a, the angle of the lift arm 32b, the angle of the lift arm 32c, the extension or retraction of the intermediate lift arm 32d relative to the lift arm 32c, the angle of the platform assembly 16 relative to the intermediate lift arm 32d about the axis 28 (e.g., shown as angle 604, controlled by motor 26), the angle of the platform assembly 16 relative to the intermediate lift arm 32d about the axis 25 (shown as angle 608, controlled by actuator 34d) in order to follow a surface (e.g., wall 352, wall 353, wall 402, wall 403, etc.) at a desired distance. In some embodiments, the follow surface control manager 112 uses the surface detection data to generate a mapping of the surface, and determines appropriate orientations of the various members of the lift device 10 to move along the mapped surface. In some embodiments, the follow surface control manager 112 is configured to use the surface detection data as feedback while providing adjusted or new values of angles and extension of the lift arms of the lift device 10 in order to move the platform assembly 16 along the surface while maintaining a specific distance. The follow surface control manager 112 provides the adjustments or new values for the turntable 70, the angle of the lift arm 32a, the angle of the lift arm 32b, the angle of the lift arm 32c, the extension or retraction of the intermediate lift arm 32d relative to the lift arm 32c, the angle of the platform assembly 16 relative to the intermediate lift arm 32d about the axis 28 (e.g., shown as angle 604, controlled by motor 26), the angle of the platform assembly 16 relative to the intermediate lift arm 32d about the axis 25 to the control signal generator 114 for use in generating and providing control signals to the turntable motor 44, the actuators 34, the actuator 35, the motor 26, etc., while receiving the surface detection data from the platform sensors 202 as feedback.

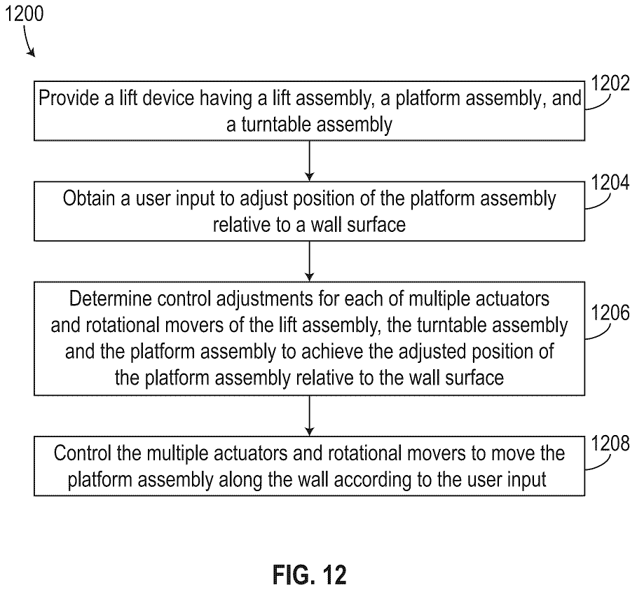

Referring to FIG. 12, a flow diagram of a process 1200 for operating a lift device according to relative control inputs (e.g., relative to a surface) includes steps 1202-1208, according to some embodiments. The process 1200 or portions thereof may be performed by the detection and control system 100 according to a follow surface mode of operation in which sensor feedback is used to adjust movement of the platform assembly 16 relative to a surface (e.g., following a curved surface) or according to a fixed plane mode of operation to adjust movement of the platform assembly 16 according to a fixed plane (e.g., a fixed coordinate system).

The process 1200 includes providing a lift device having a lift assembly, a platform assembly, and a turntable assembly (step 1202), according to some embodiments. In some embodiments, the lift device is the lift device 10. In some embodiments, one or more of the lift assembly, the platform assembly, and the turntable assembly are controlled by electric actuators, electric motors, hydraulic actuators, hydraulic rotary motors, etc. In some embodiments, the platform assembly is coupled with the lift assembly such that the platform assembly can be raised or lowered and rotated about multiple axes to facilitate reaching elevated locations. In some embodiments, the lift assembly is coupled with the turntable assembly and supported by the turntable assembly. The turntable assembly may operate to rotate about a base of the lift device to thereby adjust an overall orientation of the lift assembly.

The process 1200 also include obtaining a user input to adjust a position of the platform assembly relative to a wall surface (step 1204), according to some embodiments. In some embodiments, the user input is provided via the user interface 20 or a human machine interface (HMI) at the platform assembly 16 (or at the base assembly). The user input is a requested movement of the platform assembly 16 relative to a wall which the lift device is servicing. For example, the user input may include a request to move the platform assembly upwards along the wall, downwards along the wall, left or right along the wall, or closer or further from the wall. Instead of being an input to absolutely move the platform assembly up or down, or to directly control the turntable assembly, the user input is provided and used as a request to move the platform assembly relative to the wall surface. The wall surface may be a planar surface, a concave surface, a convex surface, or an irregularly shaped surface.

The process 1200 includes determining control adjustments for each of multiple actuators and rotational movers of the lift assembly, the turntable assembly, and the platform assembly to achieve the adjusted position (or the requested continual movement) of the platform assembly relative to the wall surface (step 1206), according to some embodiments. In some embodiments, step 1206 includes determining rate of change, adjustments, or new values for any of the angle θ_{r1,z}, the angle 75a, the angle 75b, the angle 75c, the length of the lift arm 32c and the lift arm 32d, the angle 608 of the platform assembly 16 relative to the intermediate lift arm 32d about the axis 25, and the angle 604 of the platform assembly 16 relative to the intermediate lift arm 32d about the axis 28. Step 1206 can be performed in order to achieve a position of the platform assembly that is in a fixed plane, or to maintain a distance along a curved wall surface (e.g., a concave or a convex wall) using feedback from position sensors on the platform assembly. Step 1206 may be performed by the follow surface control manager 112.

The process 1200 includes controlling the multiple actuators and rotational movers to move the platform assembly along the wall surface according to the user input (step 1208), according to some embodiments. In some embodiments, step 1208 is performed by generating control signals and providing the control signals to the actuators and rotational movers of the lift device (e.g., turntable motor 44, actuators 34, actuator 35, motor 26, etc.). In some embodiments, step 1208 is performed based on the results of step 1206. In some embodiments, step 1208 is performed by the control signal generator 114.

### Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the lift device 10 and control system 100 as shown in the various exemplary embodiments is illustrative only. Additionally, any element disclosed in one embodiment may be incorporated or utilized with any other embodiment disclosed herein. For example, the techniques of the platform sensors 202 of the exemplary embodiment shown in at least FIG. 13 may be incorporated in the lift device 10 of the embodiment shown in at least FIG. 5. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A lift device comprising:
a base assembly;
a lift assembly coupled with the base assembly, the lift assembly configured to raise or lower;
a platform assembly coupled with an end of the lift assembly, the platform assembly configured to be raised and lowered by the lift assembly; and
a control system comprising processing circuitry configured to:
receive a user input, the user input comprising a request to move the platform assembly in a direction along a wall surface relative to the wall surface while maintaining a constant distance from the wall surface and orientation relative to the wall surface; and
operate at least the lift assembly to move the platform assembly in the direction along the wall surface.

2. The lift device of claim 1, wherein the user input comprises a request to move the platform assembly upwards along the wall surface, downwards along the wall surface, left along the wall surface, or right along the wall surface.

3. The lift device of claim 1, wherein the user input comprises a request to move the platform assembly in the direction along the wall surface in a fixed coordinate system that is offset from the wall surface.

4. The lift device of claim 1, wherein the control system is configured to operate at least the lift assembly to move the platform assembly in the direction along a concave surface.

5. The lift device of claim 1, wherein the control system is configured to operate at least the lift assembly to move the platform assembly in the direction along a convex surface.

6. The lift device of claim 1, wherein the control system is configured to operate at least the lift assembly to move the platform assembly in the direction along a flat surface.

7. The lift device of claim 1, wherein the control system further comprises a plurality of sensors disposed on the platform assembly, the plurality of sensors configured to measure a distance between the platform assembly and the wall surface, wherein the processing circuitry is configured to operate the lift assembly according to the request to move the platform assembly in the direction along the wall surface while maintaining a specific distance between the platform assembly and the wall surface based on feedback from the plurality of sensors.

8. A system for a lift device, comprising:
a platform assembly coupled with an end of a lift assembly, the platform assembly configured to be raised and lowered by the lift assembly; and
processing circuitry, configured to:
receive a user input, the user input comprising a request to move the platform assembly in a direction along a local coordinate system of a wall surface; and
operate at least the lift assembly to move the platform assembly in the direction along the wall surface.

9. The system of claim 8, wherein the user input comprises a request to move the platform assembly upwards along the wall surface, downwards along the wall surface, left along the wall surface, or right along the wall surface.

10. The system of claim 8, wherein the user input comprises a request to move the platform assembly in the direction along the wall surface in a fixed plane that is offset from the wall surface.

11. The system of claim 8, wherein the system is configured to operate at least the lift assembly to move the platform assembly in the direction along a concave surface.

12. The system of claim 8, wherein the system is configured to operate at least the lift assembly to move the platform assembly in the direction along a convex surface.

13. The system of claim 8, wherein the system is configured to operate at least the lift assembly to move the platform assembly in the direction along a flat surface.

14. The system of claim 8, wherein the system further comprises a plurality of sensors disposed on the platform assembly, the plurality of sensors configured to measure a distance between the platform assembly and the wall surface, wherein the processing circuitry is configured to operate the lift assembly according to the request to move the platform assembly in the direction along the wall surface while maintaining a specific distance between the platform assembly and the wall surface based on feedback from the plurality of sensors.

15. A method of controlling a lift device, comprising:
obtaining a user input indicating a requested direction of motion of a platform assembly relative to a wall surface;
determining a control of a plurality of actuators of a lift assembly on which the platform assembly is coupled; and
operating the plurality of actuators of the lift assembly to move the platform assembly in the requested direction relative to the wall surface.

16. The method of claim 15, wherein the requested direction comprises a direction of motion relative to a local coordinate system of the wall surface.

17. The method of claim 15, wherein the wall surface comprises a concave or convex wall surface and the requested direction of motion comprises a requested direction of motion of the platform assembly along the concave or convex wall while maintaining a constant distance and orientation of the platform assembly relative to the concave or convex wall.

18. The method of claim 15, further comprising:
obtaining sensor data from a plurality of sensors disposed on the platform assembly, the plurality of sensors configured to measure a distance between the platform assembly and the wall surface; and
determining the control of the plurality of actuators based on the sensor data in order to move the platform assembly in the requested direction relative to the wall surface while maintaining a specific distance and orientation between the platform assembly and the wall surface based on feedback from the plurality of sensors.

19. The method of claim 15, wherein the user input comprises an upwards, downward, left, or right direction of motion relative to the wall surface, wherein the control of the plurality of actuators are determined to move the platform assembly in the upwards, downward, left, or right direction of motion relative to the wall surface while maintaining a specific distance between the platform assembly and the wall surface.

20. The method of claim 15, further comprising:
obtaining a selection of a mode of operation from a plurality of modes of operation comprising a distance mode or a fixed plane mode;
wherein in the distance mode, the method comprises operating the lift assembly to maintain a current distance between the platform assembly and the wall surface; and
wherein in the fixed plane mode, the method comprises operating the lift assembly to maintain the platform assembly within a fixed plane of movement at a fixed orientation.
